(19) United States
(12) Patent Application Publication
(10) Pub. No.: US 2021/0239293 A1
(43) Pub. Date: Aug. 5, 2021

(54) VEHICLE LAMP

(71) Applicant: KOITO MANUFACTURING CO., LTD., Tokyo (JP)

(72) Inventors: Naotaka MOCHIDA, Shizuoka-shi (JP); Yuji YASUDA, Shizuoka-shi (JP); Takahito WATANABE, Shizuoka-shi (JP)

(73) Assignee: KOITO MANUFACTURING CO., LTD., Tokyo (JP)

(21) Appl. No.: 17/236,077

(22) Filed: Apr. 21, 2021

Related U.S. Application Data
(63) Continuation of application No. PCT/JP2019/039270, filed on Oct. 4, 2019.

(30) Foreign Application Priority Data
Oct. 22, 2018 (JP) 2018-198721
Oct. 22, 2018 (JP) 2018-198722
Oct. 22, 2018 (JP) 2018-198723
Oct. 22, 2018 (JP) 2018-198724

(51) Int. Cl. F21S 41/33; F21S 41/19; F21S 45/47; F21S 41/148

(52) U.S. Cl. CPC F21S 41/334; F21S 41/19; F21Y 2115/10; F21S 41/148; F21S 45/47

(57) ABSTRACT

A vehicle lamp includes: an LED circuit substrate on which an LED is mounted; a base part that supports the LED circuit substrate; a reflector that extends from the base part and reflects light from the LED; and a heat absorbing plate provided to cover a surface of the base part opposite to a surface that supports the LED circuit substrate.

### BACKGROUND OF THE INVENTION

### 1. Field of the Invention

The present invention relates to a vehicle lamp.

### 2. Description of the Related Art

Vehicle lamps including an LED substrate on which an LED as a light source is mounted, a base part that supports the LED substrate, and a reflector that extends from the base part have been known in the related art (see, for example, patent document 1).

[Patent Document 1] JP2016-225240

In the vehicle lamps as described above, the base part may be heated by sunlight reflected by the reflector. It is not preferable that the base part supporting the light emitting device is heated excessively.

### SUMMARY OF THE INVENTION

The present invention addresses the above-described issue and a purpose thereof is to provide a vehicle lamp capable of preventing a base part supporting a light emitting device from being heated excessively.

A vehicle lamp according to an embodiment of the present invention includes: a circuit substrate on which a light emitting device is mounted; a base part that supports the circuit substrate; a reflector that extends from the base part and reflects light from the light emitting device; and a heat absorbing plate provided to cover a surface of the base part opposite to a surface that supports the circuit substrate.

Another embodiment of the present invention also relates to a vehicle lamp. The vehicle lamp includes: a circuit substrate on which a light emitting device is mounted; a base part that supports the circuit substrate; and a reflector that extends from the base part and reflects light from the light emitting device. The base part and the reflector are integrally molded by injection molding, and a slit is provided in a root part of the reflector with respect to the base part.

Another embodiment of the present invention also relates to a vehicle lamp. The vehicle lamp includes: a circuit substrate on which a light emitting device is mounted; a base part that supports the circuit substrate; a reflector that extends from the base part and reflects light from the light emitting device; and a reinforcing rib having a polygonal shape and formed on a surface of the base part on a side of the circuit substrate.

Another embodiment of the present invention also relates to a vehicle lamp. The vehicle lamp includes: a circuit substrate on which a light emitting device is mounted; a flexible printed substrate joined to a surface of the circuit substrate on which the light emitting device is mounted; and a heat sink provided on a surface of the circuit substrate opposite to the surface on which the light emitting device is mounted. The heat sink includes a support part that supports the flexible printed substrate such that the flexible printed substrate is spaced apart from an edge part of the circuit substrate.

Another embodiment of the present invention also relates to a vehicle lamp. The vehicle lamp includes: a base part; a circuit substrate provided on the base part; and a flexible printed substrate joined to a surface of the circuit substrate opposite to a surface on a side of the base part. The base part includes a support part that supports the flexible printed substrate such that the flexible printed substrate is spaced apart from an edge part of the circuit substrate.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic front view of a vehicle lamp according to the first embodiment of the present invention;

FIG. 2 is a schematic exploded perspective view of the lamp unit;

FIG. 3 is an A-A schematic cross-sectional view of the lamp unit shown in FIG. 1;

FIG. 4 is a perspective view for explaining how the heat absorbing plate is fitted to the base part;

FIG. 5 is a perspective view of the reflector unit as viewed from below;

FIG. 6 is a schematic front view of a vehicle lamp according to the second embodiment of the present invention;

FIG. 7 is a schematic exploded perspective view of the lamp unit;

FIG. 8 is an A-A schematic cross-sectional view of the lamp unit shown in FIG. 6;

FIG. 9 is a B-B cross-sectional view of the reflector unit shown in FIG. 6;

FIG. 10 is a cross-sectional view of a reflector unit according to the comparative example;

FIG. 11 shows the lower surface of the reflector unit according to the second embodiment;

FIG. 12 is a schematic front view of a vehicle lamp according to the third embodiment of the present invention;

FIG. 13 is a schematic exploded perspective view of the lamp unit;

FIG. 14 is an A-A schematic cross-sectional view of the lamp unit shown in FIG. 12;

FIG. 15 is a top view of the lamp unit according to the third embodiment;

FIG. 16 is a schematic front view of a vehicle lamp according to the fourth embodiment of the present invention;

FIG. 17 is a schematic exploded perspective view of the lamp unit;

FIG. 18 is an A-A schematic cross-sectional view of the lamp unit shown in FIG. 16;

FIG. 19 is a schematic enlarged view of a C part of the lamp unit shown in FIG. 18; and

FIG. 20 is a B-B schematic cross-sectional view of the lamp unit shown in FIG. 16.

### DETAILED DESCRIPTION OF THE INVENTION

A detailed description will be given of embodiments of the present invention with reference to the drawings. Where a term indicating a direction such as “upper”, “lower”, “front”, “rear”, “left”, “right”, “inside”, “outside”, etc. is used in the specification, the term signifies a direction defined when the vehicle lamp is mounted to the vehicle.

### First Embodiment

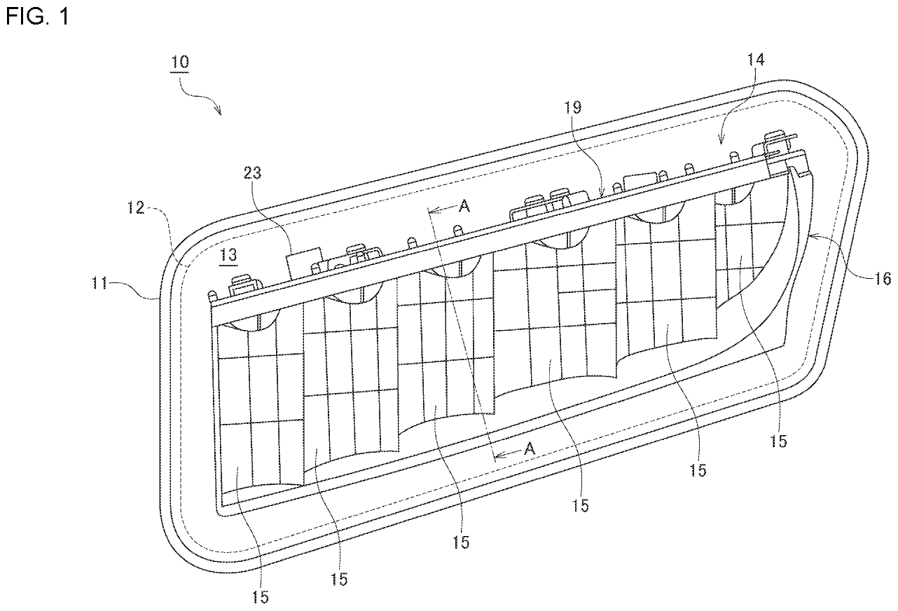

FIG. 1 is a schematic front view of a vehicle lamp 10 according to the first embodiment of the present invention. The vehicle lamp 10 is a headlight provided in the front part of the vehicle.

As shown in FIG. 1, the vehicle lamp 10 includes a lamp body 11 and a transparent outer cover 12 covering the front opening of the lamp body 11. The lamp body 11 and the outer cover 12 form a lamp chamber 13.

A lamp unit 14 is housed in the lamp chamber 13. The lamp unit 14 may be supported by a support member (not shown) so as to be tiltable relative to the lamp body 11 for the purpose of aiming control.

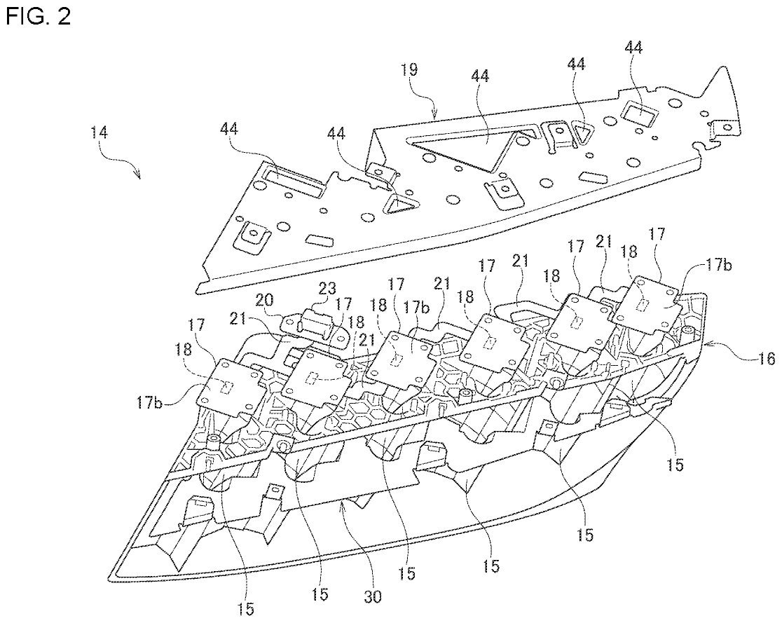

FIG. 2 is a schematic exploded perspective view of the lamp unit 14. As shown in FIGS. 1 and 2, the lamp unit 14 includes a reflector unit 16, six LED circuit substrates 17, LEDs 18 mounted on the respective LED circuit substrates 17, a heat sink 19, a connector circuit substrate 20, a connector 23 mounted on the connector circuit substrate 20, and a flexible printed substrate 21 for connecting the LED circuit substrate 17 and the connector circuit substrate 20 by a wire.

The reflector unit 16 has six reflectors 15 of parabolic type arranged in the direction of vehicle width. One LED circuit substrate 17 and one LED 18 are provided in each reflector 15, forming a reflection optical system of parabolic type.

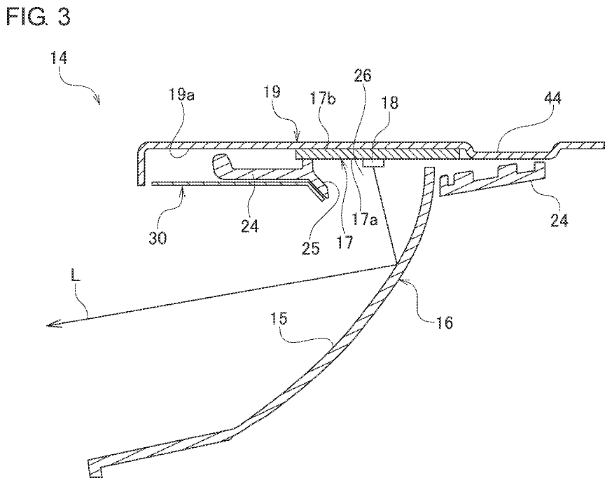

FIG. 3 is an A-A schematic cross-sectional view of the lamp unit 14 shown in FIG. 1. The reflector unit 16 includes a base part 24 of a flat plate shape, the reflector 15 as a light control member for controlling light from the LED 18, and a shade 25. The base part 24, the reflector 15 and the shade 25 are integrally formed by using a resin material such as polycarbonate and acryl. Aluminum is deposited on the surface of the reflector 15 to form a reflecting surface for reflecting the light from the LED 18.

The base part 24 is formed with a hole part 26 for guiding the light from the LED 18 to the reflector 15. The reflector 15 extends forward and diagonally downward from the rear portion of the hole part 26 in the base part 24. The reflector 15 is a reflector of parabolic type that reflects the light from the LED 18 forward with respect to the lamp. The reflector 15 has a reflecting surface formed with reference to a paraboloid of revolution. The rotational axis of the paraboloid of revolution of the reflecting surface represents the light axis of the reflector 15. The reflector 15 is provided such that the light axis is aligned with the vehicle's longitudinal direction (horizontal direction). The LED 18 is provided at the focal position of the reflecting surface of the reflector 15. The embodiment is non-limiting as to the material forming the reflector 15. Polycarbonate or acryl may be used.

The shade 25 is provided in a front portion of the hole part 26 in the base part 24. The shade 25 prevents the light from the LED 18 from being output from the lamp directly.

The LED circuit substrate 17 is supported on the base part 24 of the reflector unit 16. The LED circuit substrate 17 is a plate-shaped body made of a metal such as aluminum. The lower surface of the LED circuit substrate 17 is an LED mounting surface 17a. An insulating film is formed on the LED mounting surface 17a. The LED 18 is mounted on the insulating film such that the light emission surface faces downward. A circuit pattern for feeding power to the LED 18 is formed on the insulating film. As described above, the LED 18 is provided at the focal position of the reflecting surface of the reflector 15. The LED 18 is supplied with an electric current from the LED circuit substrate 17 to emit light. FIG. 3 shows an example of light ray (light ray L) emitted from the LED 18, reflected by the reflecting surface of the reflector 15, and output forward with respect to the lamp.

A cable (not shown) from a current source outside the lamp chamber is connected to the connector 23 (see FIGS. 1 and 2). The current for causing the LED 18 to emit light is supplied to each LED circuit substrate 17 from the connector circuit substrate 20 via the flexible printed substrate 21.

The heat sink 19 is a substantially plate-shaped body made of a metal such as aluminum having a high heat conductivity. The heat sink 19 is provided on the side of an upper surface 17b opposite to the LED mounting surface 17a of the LED circuit substrate 17. The upper surface 17b of the LED circuit substrate 17 and the lower surface 19a of the heat sink 19 are in contact. The heat generated from the LED 18 is conducted to the heat sink 19 via the LED circuit substrate 17 and dissipated to the air inside the lamp chamber 13. A thermal conductive grease may be applied between the upper surface 17b of the LED circuit substrate 17 and the lower surface 19a of the heat sink 19 in order to enhance the heat conductivity.

The lamp unit 14 according to the first embodiment further includes a heat absorbing plate 30 provided to cover the surface opposite to the surface supporting the LED circuit substrate 17 of the base part 24 (the surface on the side of the reflector 15). The heat absorbing plate 30 covers, as shown in FIG. 3, the front portion (including the shade 25) of the hole part 26 in the base part 24.

As described above, the reflecting surface of the reflector 15 is for reflecting the light from the LED 18 but also receives and reflects sunlight in the daytime. It is not preferable that the reflected sunlight directly irradiates the base part 24 to heat the base part 24 excessively because it might, for example, induce degradation of the resin material forming the base part 24. This is addressed in the first embodiment by causing the heat absorbing plate 30 provided to cover the surface of the base part 24 to absorb the sunlight reflected by the reflector 15 and preventing the base part 24 from being heated excessively by the reflected sunlight.

The heat absorbing plate 30 may be a plate-shaped body made of a metal material such as iron having a high thermal absorptivity. It is further preferable that the heat absorbing plate 30 be colored with a color such as black having a high thermal absorptivity. In these cases, the sunlight reflected by the reflector 15 is more suitably absorbed, and the base part 24 is inhibited from being heated more successfully. It should be noted that black encompasses gray.

Further, in the case the heat absorbing plate 30 is colored in black, etc., for example, the color of the heat absorbing plate 30 is reflected on the reflector 15. It is therefore possible to realize the vehicle lamp 10 having an appearance difference from the one with the ordinary silver reflector 15. In this case, the heat absorbing plate 30 can be viewed as functioning as a “decorative member”.

It is possible to cause black, etc. to be reflected on the reflector 15 coloring the surface of the base part 24 in black etc. It will, however, require, for example, a step of masking the reflector 15 and then painting the base part 24, making the steps of manufacturing the reflector unit 16 complicated. By configuring the heat absorbing plate 30 to be a component separate from the reflector unit 16 as in the first embodiment, the steps of manufacturing the reflector unit 16 are prevented from becoming complicated.

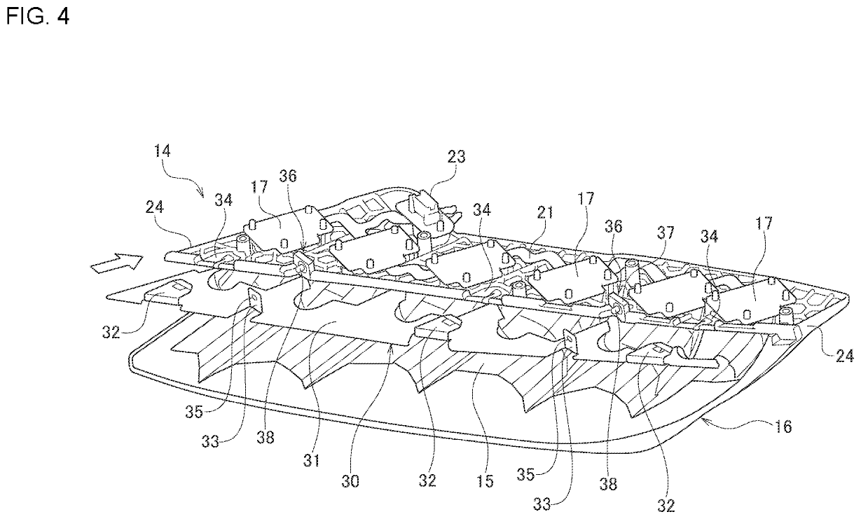

FIG. 4 is a perspective view for explaining how the heat absorbing plate 30 is fitted to the base part 24. As shown in FIG. 4, the heat absorbing plate 30 has a flat-plate part 31 for covering the surface of the base part 24 and a sandwiching part 32 and a fixing part 33 provided in front of the flat-plate part 31 with respect to the lamp.

The sandwiching part 32 is shaped in the form of a clip to sandwich a sandwiched part 34 provided at the front end of the base part 24. The fixing part 33 is an upward projecting piece produced by bending the flat-plate part 31 perpendicularly and is formed with a hole 35. The front end of the base part 24 is formed with a heat swaging part 36. The heat swaging part 36 is comprised of a projecting part 37 that projects upward from the base part 24 and a pin part 38 that projects from the projecting part 37 forward with respect to the lamp. The heat swaging part 36 is resin-molded so as to be integrated with the base part 24.

When the heat absorbing plate 30 is fitted to the base part 24, the heat absorbing plate 30 is first introduced into the space between the base part 24 and the reflector 15 from in front of the lamp. The sandwiching part 32 of the heat absorbing plate 30 is then introduced into the sandwiched part 34 of the base part 24. This causes the sandwiching part 32 to be fixed to and sandwich the sandwiched part 34. In this process, the pin part 38 of the heat swaging part 36 is inserted into the hole 35 of the fixing part 33. Thereafter, the fixing part 33 is fixed to the heat swaging part 36 by heat swaging when the leading edge of the pin part 38 is melted by an electric swaging tool.

By fixing components permanently by heat swaging in this way in the first embodiment, the easiness of assembly is improved and the number of components is reduced as compared with the case of using a fastening member such as a screw. Accordingly, the weight and cost are reduced. Further, the easiness of assembly is improved by temporarily fixing the sandwiching part 32 and then permanently fixing the fixing part 33 by heat swaging. Further, by employing two different fixing methods, stability in the presence of vibration or shock during the travel is improved.

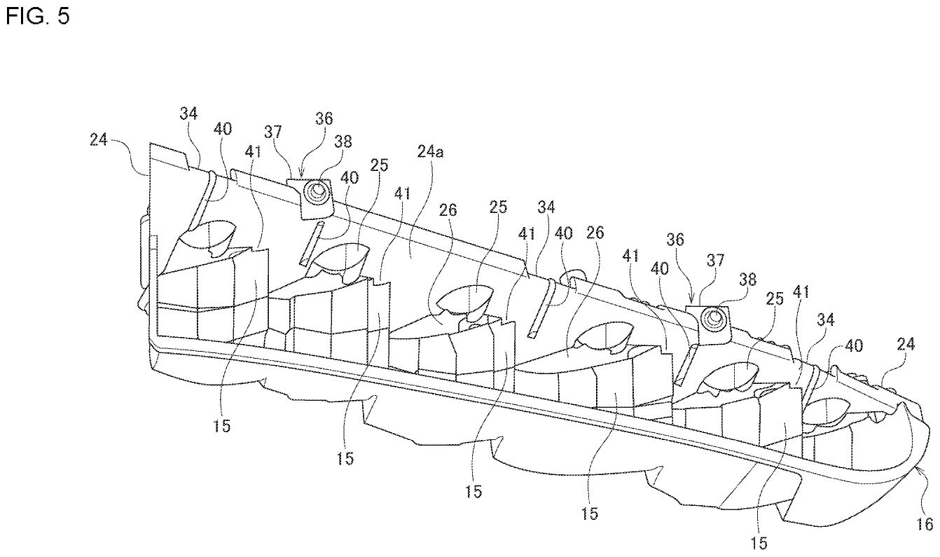

FIG. 5 is a perspective view of the reflector unit 16 as viewed from below. FIG. 5 shows a state in which the heat absorbing plate 30 is removed. As shown in FIG. 5, a plurality of convex ribs 40 are formed at intervals on a surface 24a of the base part 24 on the side of the reflector 15 (i.e., the lower surface). The convex ribs 40 extend in the longitudinal direction of the lamp. By providing the convex ribs 40, the heat absorbing plate 30 and the convex ribs 40 will be in line contact when the heat absorbing plate 30 is fitted to the base part 24. Therefore, the stability of the heat absorbing plate 30 is improved as compared with the case where the convex ribs 40 are not provided, and the heat absorbing plate 30 and the lower surface 24a of the base part 24 are in plane contact.

As shown in FIG. 5, a notch 41 may be provided in a part of the reflector 15 to support the rear end of the heat absorbing plate 30 inserted therein. In this case, the stability of the heat absorbing plate 30 is further improved.

### Second Embodiment

In the vehicle lamp, the base part and the reflector may be integrally molded by injection molded. In this case, the root part of the reflector with respect to the base part becomes thick so that a sink (indentation on the surface) may be produced on the reflector surface. When a sink is produced on the reflector surface, desired light distribution may not be realized.

The second embodiment addresses this issue and a purpose thereof is to prevent a sink from being produced on the reflector surface in a vehicle lamp in which a base part for supporting an LED substrate and a reflector extending from the base part are integrally molded by injection molding.

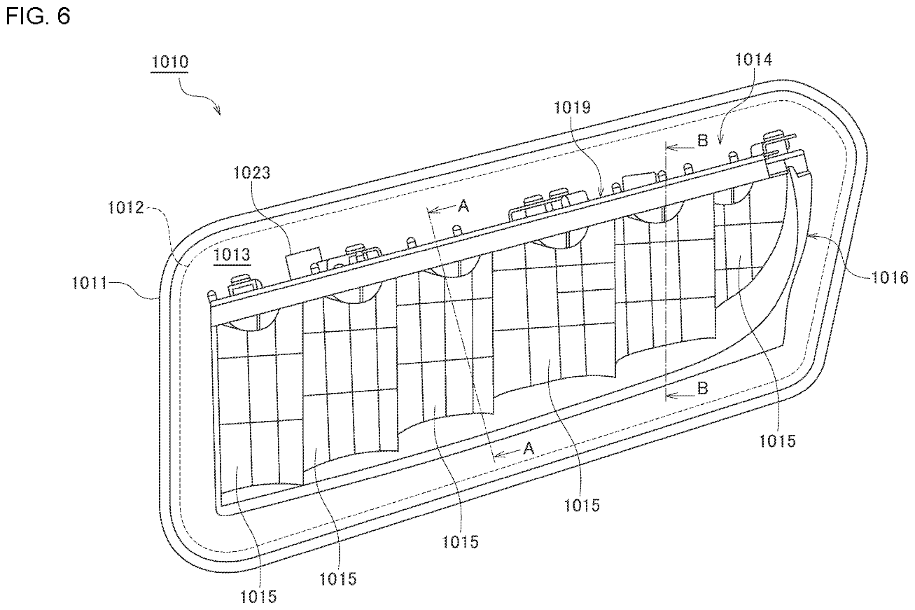

FIG. 6 is a schematic front view of a vehicle lamp 1010 according to the second embodiment of the present invention. The vehicle lamp 1010 is a headlamp provided in the front part of the vehicle.

As shown in FIG. 6, the vehicle lamp 1010 includes a lamp body 1011 and a transparent outer cover 1012 covering the front opening of the lamp body 1011. The lamp body 1011 and the outer cover 1012 form a lamp chamber 1013.

A lamp unit 1014 is housed in the lamp chamber 1013. The lamp unit 1014 may be supported by a support member (not shown) so as to be tiltable relative to the lamp body 1011 for the purpose of aiming control.

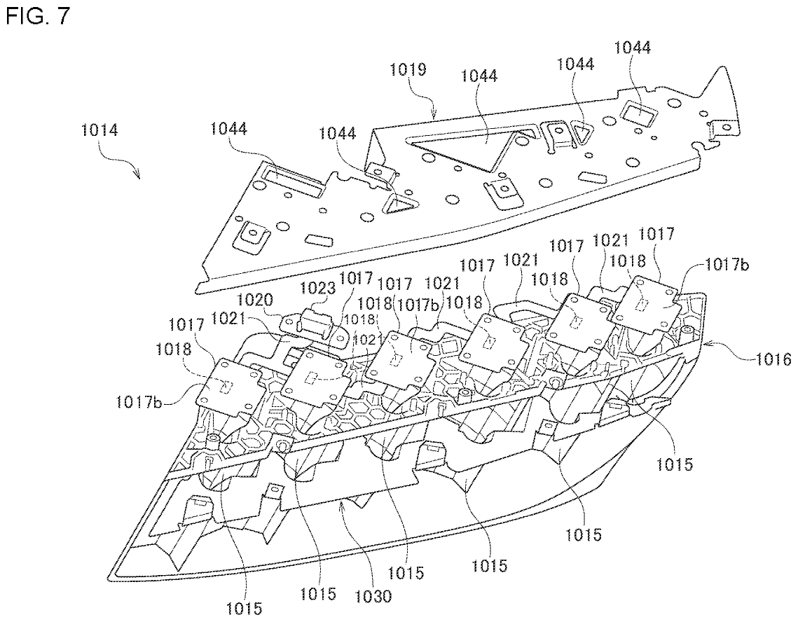

FIG. 7 is a schematic exploded perspective view of the lamp unit 1014. As shown in FIGS. 6 and 7, the lamp unit 1014 includes a reflector unit 1016, six LED circuit substrates 1017, LEDs 1018 mounted on the respective LED circuit substrates 1017, a heat sink 1019, a connector circuit substrate 1020, a connector 1023 mounted on the connector circuit substrate 1020, and a flexible printed substrate 1021 for connecting the LED circuit substrate 1017 and the connector circuit substrate 1020 by a wire.

The reflector unit 1016 has six reflectors 1015 of parabolic type arranged in the direction of vehicle width. One LED circuit substrate 1017 and one LED 1018 are provided in each reflector 1015, forming a reflection optical system of parabolic type.

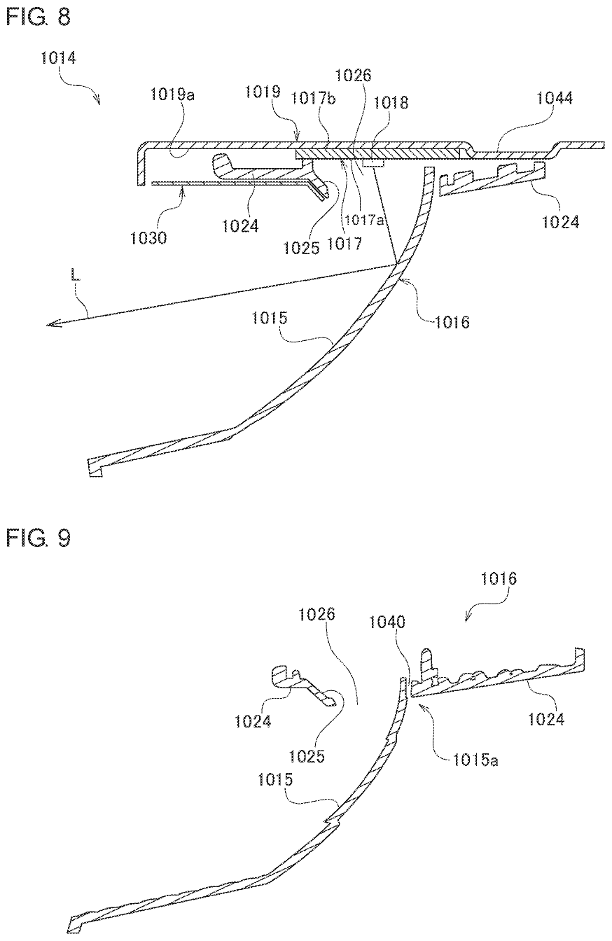

FIG. 8 is an A-A schematic cross-sectional view of the lamp unit 1014 shown in FIG. 6. The reflector unit 1016 includes a base part 1024 of a flat plate shape, the reflector 1015 as a light control member for controlling light from the LED 1018, and a shade 1025. The base part 1024, the reflector 1015 and the shade 1025 are integrally molded by injection molding, using a resin material such as polycarbonate and acryl. Aluminum is deposited on the surface of the reflector 1015 to form a reflecting surface for reflecting the light from the LED 1018.

The base part 1024 is formed with a hole part 1026 for guiding the light from the LED 1018 to the reflector 1015. The reflector 1015 extends forward and diagonally downward from the rear portion of the hole part 1026 in the base part 1024. The reflector 1015 is a reflector of parabolic type that reflects the light from the LED 1018 forward with respect to the lamp. The reflector 1015 has a reflecting surface formed with reference to a paraboloid of revolution. The rotational axis of the paraboloid of revolution of the reflecting surface represents the light axis of the reflector 1015. The reflector 1015 is provided such that the light axis is aligned with the vehicle's longitudinal direction (horizontal direction). The LED 1018 is provided at the focal position of the reflecting surface of the reflector 1015.

The shade 1025 is provided in the front portion of the hole part 1026 in the base part 1024. The shade 1025 prevents the light from the LED 1018 from being output from the lamp directly.

The LED circuit substrate 1017 is supported on the base part 1024 of the reflector unit 1016. The LED circuit substrate 1017 is a plate-shaped body made of a metal such as aluminum. The lower surface of the LED circuit substrate 1017 is an LED mounting surface 1017a. An insulating film is formed on the LED mounting surface 1017a. The LED 1018 is mounted on the insulating film such that the light emission surface faces downward. A circuit pattern for feeding power to the LED 1018 is formed on the insulating film. As described above, the LED 1018 is provided at the focal position of the reflecting surface of the reflector 1015. The LED 1018 is supplied with an electric current from the LED circuit substrate 1017 to emit light. FIG. 8 shows an example of light ray (light ray L) emitted from the LED 1018, reflected by the reflecting surface of the reflector 1015, and output forward with respect to the lamp.

A cable (not shown) from a current source outside the lamp chamber is connected to the connector 1023 (see FIGS. 6 and 7). The current for causing the LED 1018 to emit light is supplied to each LED circuit substrate 1017 from the connector circuit substrate 1020 via the flexible printed substrate 1021.

The heat sink 1019 is a substantially plate-shaped body made of a metal such as aluminum having a high heat conductivity. The heat sink 1019 is provided on the side of an upper surface 1017b opposite to the LED mounting surface 1017a of the LED circuit substrate 1017. The upper surface 1017b of the LED circuit substrate 1017 and the lower surface 1019a of the heat sink 1019 are in contact. The heat generated from the LED 1018 is conducted to the heat sink 1019 via the LED circuit substrate 1017 and dissipated to the air inside the lamp chamber 1013. A thermal conductive grease may be applied between the upper surface 1017b of the LED circuit substrate 1017 and the lower surface 1019a of the heat sink 1019 in order to enhance the heat conductivity.

The lamp unit 1014 according to the second embodiment further includes a heat absorbing plate 1030 provided to cover the surface of the base part 1024 on the side of the reflector 1015. The heat absorbing plate 30 covers, as shown in FIG. 8, the front portion (including the shade 1025) of the hole part 1026 in the base part 1024. The heat absorbing plate 1030 absorbs the sunlight reflected by the reflector 1015 and prevents the base part 1024 from being heated excessively by the reflected sunlight.

FIG. 9 is a B-B cross-sectional view of the reflector unit 1016 shown in FIG. 6. In the vehicle lamp 1010 according to the second embodiment, a slit 1040 is provided in a root part 1015a of the reflector 1015 with respect to the base part 1024. The slit 1040 is formed to extend through the base part 1024.

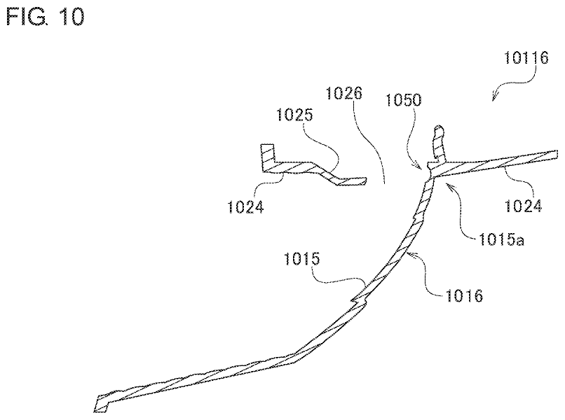

A comparative example will be shown to explain the benefit of the slit 1040 according to the second embodiment. FIG. 10 is a cross-sectional view of a reflector unit 1116 according to the comparative example. As shown in FIG. 10, a slit is not formed in a root part 1015a of the reflector 1015 in the reflector unit 1116 according to the comparative example. In this case, the root part 1015a will be thicker than the other parts of the reflector 1015 and the base part 1024. Consequently, a sink 1050 may be produced on the surface of the reflector 1015 when the reflector unit 1116 is molded by injection molding. A “sink” is an indentation produced on the surface of the reflector. When a sink 1050 is produced on the surface of the reflector 1015, desired light distribution may not be realized because the light from the LED 1018 is reflected by the sink 1050 in an unintended direction.

This is addressed in the second embodiment by providing the slit 1040 to prevent the root part 1015a of the reflector 1015 from becoming thick and ensuring that thickness of the root part 1015a of the reflector 1015 is substantially equal to the thickness (e.g., 2 mm) of the other parts of the reflector 1015. Stated otherwise, the slit 1040 is provided, in the second embodiment, in the root part 1015a of the reflector 1015 to reduce the thickness. This prevents a sink from being produced on the surface of the reflector 1015 so that desired light distribution is realized.

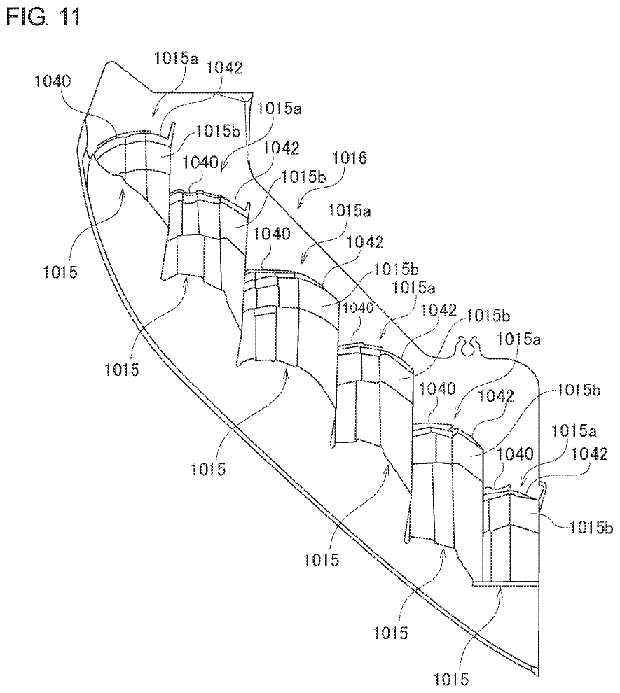

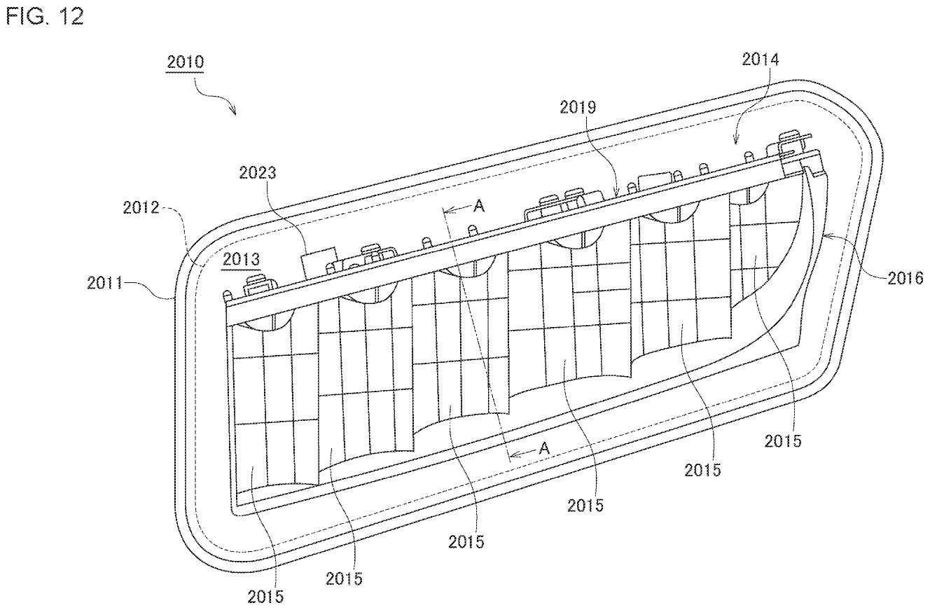

FIG. 11 shows the lower surface of the reflector unit 1016 according to the second embodiment. As shown in FIG. 11, the slit 1040 is provided in the root part 1015a of each reflector 1015. In the second embodiment, the slit is not formed over the entirety of the root part 1015a of the reflector 1015, and a part of the root part 1015a of the reflector 1015 is made to remain as a part 1042 in which the slit is not formed (slit-less part).

The reflecting surface of the reflector 1015 is segmented into a plurality of small sections (referred to as “small reflecting surfaces”). In the second embodiment, the root part 1015a of a small reflecting surface 1015b located at the end of the reflector 1015, where the impact on light distribution is small, is configured as a slit-less part 1042. This makes it possible to realize desired light distribution while at the same time securing the strength of the reflector 1015.

### Third Embodiment

Recently, LEDs are configured to provide an increasingly higher output. In association with this, the heat radiated from the LED has also been increased. If the base part supporting the LED substrate is deformed or the like by the heat radiated by the LED, the reflector extending from the base part is affected with the result that desired light distribution may not be realized.

The third embodiment addresses this issue, and a purpose thereof is to inhibit an impact of heat from an LED on a reflector in a vehicle lamp including a base part for supporting an LED substrate and a reflector extending from the base part.

FIG. 12 is a schematic front view of a vehicle lamp 2010 according to the third embodiment of the present invention. The vehicle lamp 2010 is a headlamp provided in the front part of the vehicle.

As shown in FIG. 12, the vehicle lamp 2010 includes a lamp body 2011 and a transparent outer cover 2012 covering the front opening of the lamp body 2011. The lamp body 2011 and the outer cover 2012 form a lamp chamber 2013.

A lamp unit 2014 is housed in the lamp chamber 2013. The lamp unit 2014 may be supported by a support member (not shown) so as to be tiltable relative to the lamp body 2011 for the purpose of aiming control.

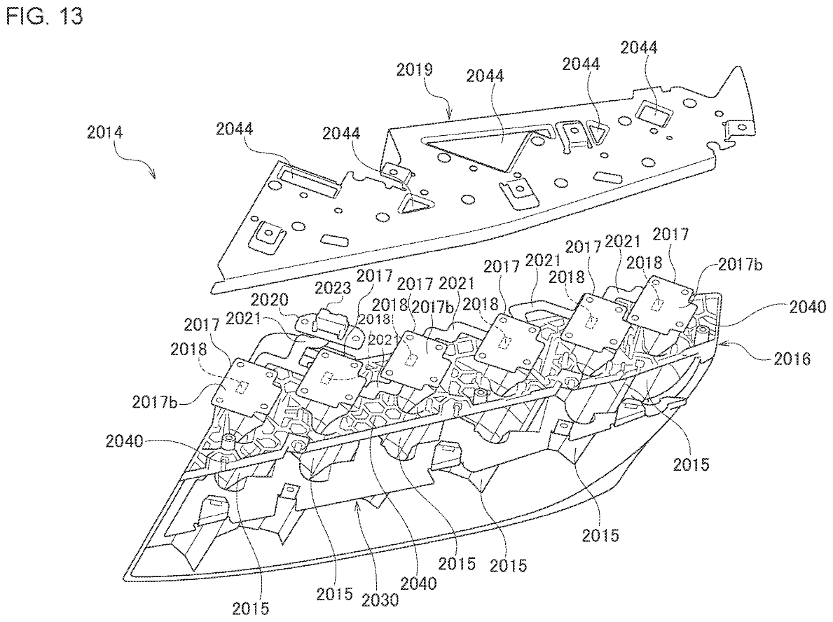

FIG. 13 is a schematic exploded perspective view of the lamp unit 2014. As shown in FIGS. 12 and 13, the lamp unit 2014 includes a reflector unit 2016, six LED circuit substrates 2017, LEDs 2018 mounted on the respective LED circuit substrates 2017, a heat sink 2019, a connector circuit substrate 2020, a connector 2023 mounted on the connector circuit substrate 2020, and a flexible printed substrate 2021 for connecting the LED circuit substrate 2017 and the connector circuit substrate 2020 by a wire.

The reflector unit 2016 has six reflectors 2015 of parabolic type arranged in the direction of vehicle width. One LED circuit substrate 2017 and one LED 2018 are provided in each reflector 2015, forming a reflection optical system of parabolic type.

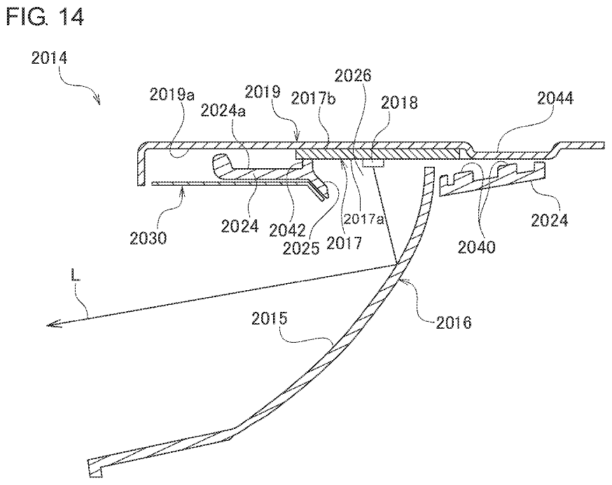

FIG. 14 is an A-A schematic cross-sectional view of the lamp unit 2014 shown in FIG. 12. The reflector unit 2016 includes a base part 2024 of a flat plate shape, the reflector 2015 as a light control member for controlling light from the LED 2018, and a shade 2025. The base part 2024, the reflector 2015 and the shade 2025 are integrally molded by injection molding, using a resin material such as polycarbonate and acryl. Aluminum is deposited on the surface of the reflector 2015 to form a reflecting surface for reflecting the light from the LED 2018.

The base part 2024 is formed with a hole part 2026 for guiding the light from the LED 2018 to the reflector 2015. The reflector 2015 extends forward and diagonally downward from the rear portion of the hole part 2026 in the base part 2024. The reflector 2015 is a reflector of parabolic type that reflects the light from the LED 2018 forward with respect to the lamp. The reflector 2015 has a reflecting surface formed with reference to a paraboloid of revolution. The rotational axis of the paraboloid of revolution of the reflecting surface represents the light axis of the reflector 2015. The reflector 2015 is provided such that the light axis is aligned with the vehicle's longitudinal direction (horizontal direction). The LED 2018 is provided at the focal position of the reflecting surface of the reflector 2015.

The shade 2025 is provided in the front portion of the hole part 2026 in the base part 2024. The shade 2025 prevents the light from the LED 2018 from being output from the lamp directly.

The LED circuit substrate 2017 is supported on the base part 2024 of the reflector unit 2016. The LED circuit substrate 2017 is a plate-shaped body made of a metal such as aluminum or is a resin substrate produced by forming a circuit pattern on a resin substrate using a copper foil, etc. The lower surface of the LED circuit substrate 2017 is an LED mounting surface 2017a. An insulating film is formed on the LED mounting surface 2017a. The LED 2018 is mounted on the insulating film such that the light emission surface faces downward. A circuit pattern for feeding power to the LED 2018 is formed on the insulating film. As described above, the LED 2018 is provided at the focal position of the reflecting surface of the reflector 2015. The LED 2018 is supplied with an electric current from the LED circuit substrate 2017 to emit light. FIG. 14 shows an example of light ray (light ray L) emitted from the LED 2018, reflected by the reflecting surface of the reflector 2015, and output forward with respect to the lamp.

A cable (not shown) from a current source outside the lamp chamber is connected to the connector 2023 (see FIGS. 12 and 13). The current for causing the LED 2018 to emit light is supplied to each LED circuit substrate 2017 from the connector circuit substrate 2020 via the flexible printed substrate 2021.

The heat sink 2019 is a substantially plate-shaped body made of a metal such as aluminum having a high heat conductivity. The heat sink 1019 is provided on the side of an upper surface 2017b opposite to the LED mounting surface 2017a of the LED circuit substrate 2017. The upper surface 2017b of the LED circuit substrate 2017 and the lower surface 2019a of the heat sink 2019 are in contact. The heat generated from the LED 2018 is conducted to the heat sink 2019 via the LED circuit substrate 2017 and dissipated to the air inside the lamp chamber 2013. A thermal conductive grease may be applied between the upper surface 2017b of the LED circuit substrate 2017 and the lower surface 2019a of the heat sink 2019 in order to enhance the heat conductivity. If the heat sink 2019 is made of a metal material in the case the LED circuit substrate 2017 is a resin substrate, the circuit substrate may be electrically shorted by the heat sink 2019. Therefore, an insulative thermal conduction sheet may be interposed between the LED circuit substrate 2017 and the heat sink 2019.

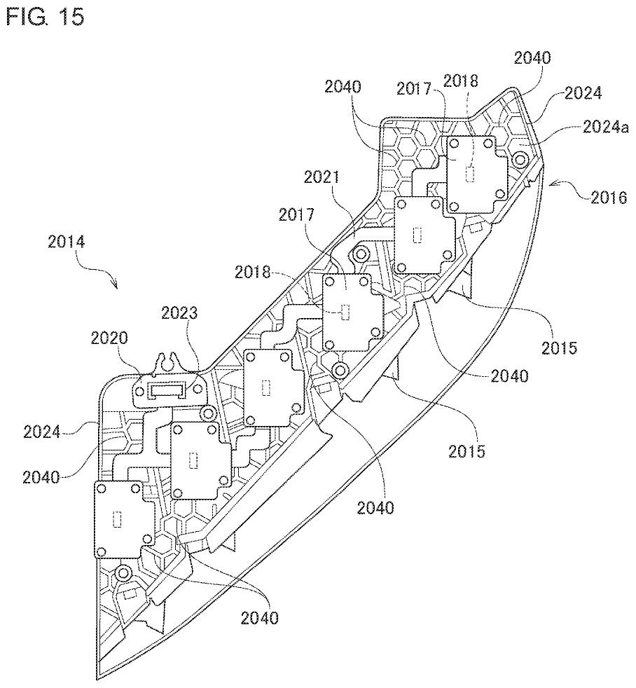

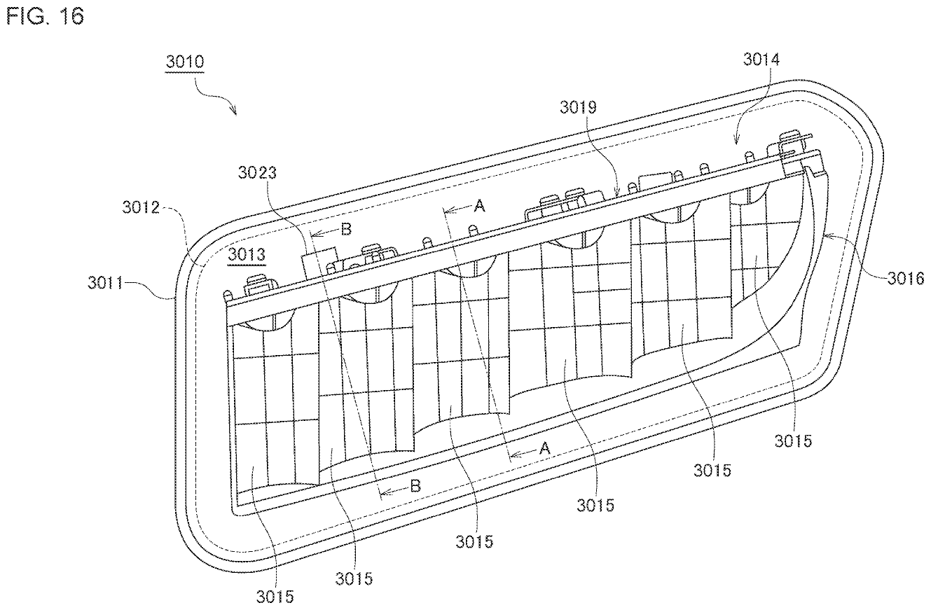

FIG. 15 is a top view of the lamp unit 2014 according to the third embodiment. FIG. 15 shows a state in which the heat sink 2019 is removed for the purpose of explanation. In the third embodiment, a polygonal reinforcing rib 2040 is formed, as shown in FIG. 15, on a surface 2024a of the base part 2024 on the side of the LED circuit substrate 2017 (i.e., the upper surface). The reinforcing rib 2040 is a rib that projects from the upper surface 2024a of the base part 2024, and the rib is formed to have a polygonal shape. The reinforcing rib 2040 and the base part 2024 are integrally molded by injection molding. In the third embodiment, the reinforcing rib 2040 is formed, as shown in FIG. 15, in a honeycomb shape comprised of a lattice of hexagons.

As described above, the heat generated from the LED is dissipated by the heat sink 2019, but a portion of the heat is conducted to the base part 2024. If the base part 2024 is deformed by the heat, the reflector 2015 integrated with the base part 2024 might be distorted, and desired light distribution might not be realized. In the third embodiment, the rigidity of the base part 2024 is improved, and the deformation of base part 2024 due to the heat is inhibited, by providing the reinforcing rib 2040 of a honeycomb shape on the upper surface 2024a of the base part 2024. As a result, distortion of the reflector 2015 is avoided, and desired light distribution is realized.

In further accordance with the third embodiment, the surface area of the base part 2024 is increased, and the heat dissipation performance of the base part 2024 is improved by providing the reinforcing rib 2040 of a honeycomb shape. Since the deformation of the reflector 2015 due to the heat from the LED 2018 is reduced, the light distribution performance is improved. By masking the reinforcing rib 2040 of a honeycomb shape and not depositing a metal on it while the metal is being deposited on the reflecting surface of the reflector 2015, a higher radiation rate is established, and the heat dissipation performance based on radiation is enhanced, as compared with the case where a metal material such as aluminum is deposited. Stated otherwise, the heat dissipation performance is enhanced by not depositing a metal on the reinforcing rib 2040 of a honeycomb shape. As a result, the distortion of the reflector 2015 is avoided, and desired light distribution is realized.

In the third embodiment, the height of the reinforcing rib 2040 is configured to be smaller than the height of an LED support part formed on the upper surface 2024a of the base part 2024 to support the LED circuit substrate 2017. By forming the reinforcing rib 2040 in this way, the LED circuit substrate 2017 is suitably supported.

### Fourth Embodiment

In a vehicle lamp, a flexible printed substrate may be used to wire an LED substrate. By using a flexible printed substrate, the configuration can be simplified and downsized.

In a vehicle lamp in which a flexible printed substrate is used, however, a trouble such as broken wires may occur in the flexible printed substrate if the flexible printed substrate and the edge part of the LED substrate come into contact repeatedly due to the vibration, etc. during the travel.

The fourth embodiment addresses this issue, and a purpose thereof is to prevent, in a vehicle lamp in which a flexible printed substrate is used, a trouble in the flexible printed substrate.

FIG. 16 is a schematic front view of a vehicle lamp 3010 according to the fourth embodiment of the present invention. The vehicle lamp 3010 is a headlamp provided in the front part of the vehicle.

As shown in FIG. 16, the vehicle lamp 3010 includes a lamp body 3011 and a transparent outer cover 3012 covering the front opening of the lamp body 3011. The lamp body 3011 and the outer cover 3012 form a lamp chamber 3013.

A lamp unit 3014 is housed in the lamp chamber 3013. The lamp unit 3014 may be supported by a support member (not shown) so as to be tiltable relative to the lamp body 3011 for the purpose of aiming control.

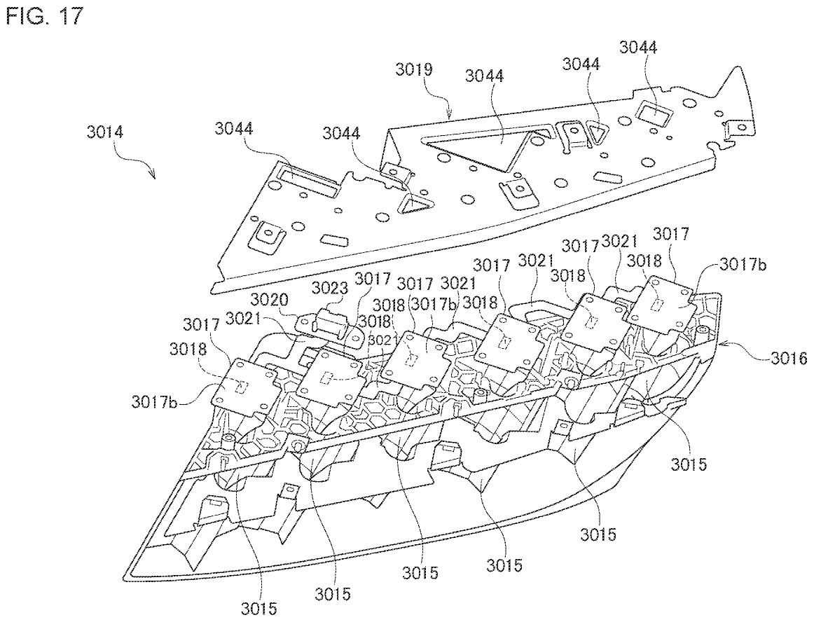

FIG. 17 is a schematic exploded perspective view of the lamp unit 3014. As shown in FIGS. 16 and 17, the lamp unit 3014 includes a reflector unit 3016, six LED circuit substrates 3017, LEDs 3018 mounted on the respective LED circuit substrates 3017, a heat sink 3019, a connector circuit substrate 3020, a connector 3023 mounted on the connector circuit substrate 3020, and a flexible printed substrate 3021 for connecting the LED circuit substrate 3017 and the connector circuit substrate 3020 by a wire.

The reflector unit 3016 has six reflectors 3015 of parabolic type arranged in the direction of vehicle width. These six reflectors 3015 are integrally formed by using a resin material. One LED circuit substrate 3017 and one LED 3018 are provided in each reflector 3015, forming a reflection optical system of parabolic type.

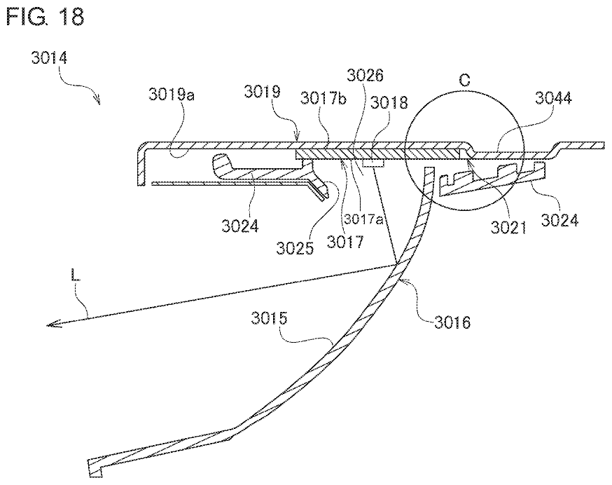

FIG. 18 is an A-A schematic cross-sectional view of the lamp unit 3014 shown in FIG. 16. The reflector unit 3016 includes a base part 3024 of a flat plate shape, the reflector 3015 as a light control member for controlling light from the LED 3018, and a shade 3025.

The base part 3024 is formed with a hole part 3026 for guiding the light from the LED 3018 to the reflector 3015. The reflector 3015 extends forward and diagonally downward from the rear portion of the hole part 3026 in the base part 3024. The reflector 3015 is a reflector of parabolic type that reflects the light from the LED 3018 forward with respect to the lamp. The reflector 3015 has a reflecting surface formed with reference to a paraboloid of revolution. The rotational axis of the paraboloid of revolution of the reflecting surface represents the light axis of the reflector 3015. The reflector 3015 is provided such that the light axis is aligned with the vehicle's longitudinal direction (horizontal direction). The LED 3018 is provided at the focal position of the reflecting surface of the reflector 3015.

The shade 3025 is provided in the front portion of the hole part 3026 in the base part 3024. The shade 3025 prevents the light from the LED 3018 from being output from the lamp directly.

The LED circuit substrate 3017 is supported on the base part 3024 of the reflector unit 3016. The LED circuit substrate 3017 is a plate-shaped body made of a metal such as aluminum. The LED circuit substrate 3017 is a plate-shaped body formed by punching out a metal plate. The lower surface of the LED circuit substrate 3017 is an LED mounting surface 3017a. An insulating film is formed on the LED mounting surface 3017a. The LED 3018 is mounted on the insulating film such that the light emission surface faces downward. A circuit pattern for feeding power to the LED 3018 is formed on the insulating film. As described above, the LED 3018 is provided at the focal position of the reflecting surface of the reflector 3015. The LED 3018 is supplied with an electric current from the LED circuit substrate 3017 to emit light. FIG. 18 shows an example of light ray (light ray L), emitted from the LED 3018, reflected by the reflecting surface of the reflector 3015, and output forward with respect to the lamp.

A cable (not shown) from a current source outside the lamp chamber is connected to the connector 3023 (see FIGS. 16 and 17). The current for causing the LED 3018 to emit light is supplied to each LED circuit substrate 3017 from the connector circuit substrate 3020 via the flexible printed substrate 3021.

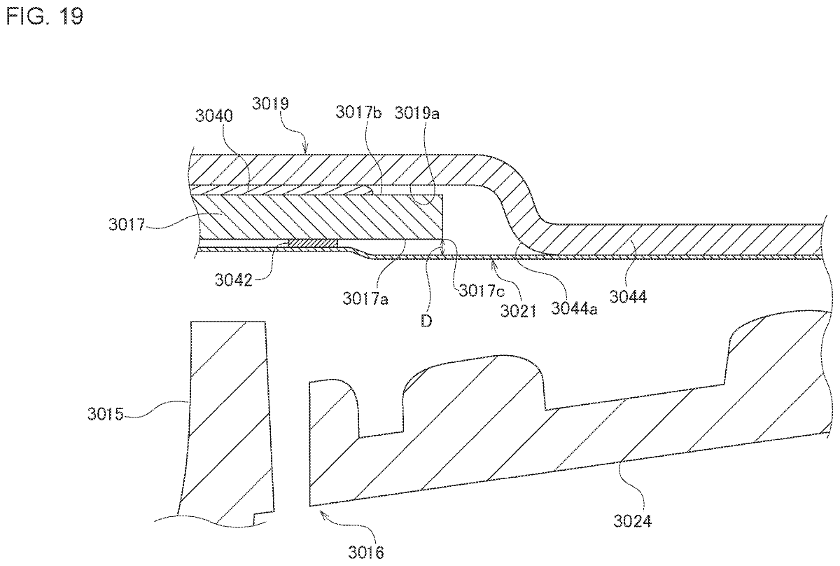

The heat sink 3019 is a substantially plate-shaped body made of a metal such as aluminum having a high heat conductivity. The heat sink 3019 is provided on the side of an upper surface 3017b opposite to the LED mounting surface 3017a of the LED circuit substrate 3017. The upper surface 3017b of the LED circuit substrate 3017 and the lower surface 3019a of the heat sink 3019 are in contact. The heat generated from the LED 3018 is conducted to the heat sink 3019 via the LED circuit substrate 3017 and dissipated to the air inside the lamp chamber 3013. A thermal conductive grease 3040 (see FIG. 19) may be applied between the upper surface 3017b of the LED circuit substrate 3017 and the lower surface 3019a of the heat sink 3019 in order to enhance the heat conductivity.

FIG. 19 is a schematic enlarged view of a C part of the lamp unit 3014 shown in FIG. 18. As shown in FIG. 19, the flexible printed substrate 3021 is joined to the LED mounting surface 3017a of the LED circuit substrate 3017 via a solder 3042.

In the vehicle lamp 3010 according to the fourth embodiment, the heat sink 3019 includes a support part 3044 that supports the flexible printed substrate 3021 such that the flexible printed substrate 3021 is spaced apart from an edge part 3017c of the LED circuit substrate 3017. As shown in FIG. 19, the flexible printed substrate 3021, a part of which is supported by the support part 3044, is curved downward from the neighborhood of the solder 3042, forming a gap D between the edge part 3017c of the LED circuit substrate 3017 and the flexible printed substrate 3021.

In the fourth embodiment, the support part 3044 is comprised of a recess formed in the heat sink 3019. A recess can be formed by press working and so is easy to form. Further, an R portion can be formed at the corner of the recess. As shown in FIG. 17, a plurality of support parts 3044 are formed in the heat sink 3019 at portions corresponding to the flexible printed substrate 3021 to support the flexible printed substrate 3021 between the adjacent LED circuit substrates 3017 and the flexible printed substrate 3021 between the LED circuit substrate 3017 and the flexible printed substrate 3021. As shown in FIG. 17, the support part 3044 may be variously shaped in accordance with the shape of the flexible printed substrate 3021 that should be supported.

As described above, in a vehicle lamp in which a flexible printed substrate is used, a trouble such as broken wires may occur in the flexible printed substrate if the flexible printed substrate and the edge part of the LED substrate come into contact repeatedly due to the vibration, etc. during the travel. This is addressed in the vehicle lamp 3010 according to the fourth embodiment by causing the support part 3044 provided in the heat sink 3019 to space the flexible printed substrate 3021 apart from the edge part 3017c of the LED circuit substrate 3017. This makes it difficult for the flexible printed substrate 3021 and the edge part 3017c of the LED circuit substrate 3017 from coming into contact due to the vibration, etc. during the travel and so prevents a trouble such as broken wires from occurring in the flexible printed substrate 3021.

Further, as described above, the LED circuit substrate 3017 is formed in the fourth embodiment by punching out a metal plate. Generally, a burr is easily produced in the edge part of a substrate formed by punching out a plate and contact between the burr and the flexible printed substrate increases the likelihood of damage to the flexible printed substrate. In the vehicle lamp 3010 according to the fourth embodiment, however, the support part 3044 provided in the heat sink 3019 spaces the flexible printed substrate 3021 apart from the edge part 3017c of the LED circuit substrate 3017 so that damage to the flexible printed substrate 3021 due to a burr is prevented.

The gap D between the edge part 3017c of the LED circuit substrate 3017 and the flexible printed substrate 3021 is preferably from 0.6 mm to 0.8 mm (both inclusive). By configuring the gap D to be 0.6 mm or larger, contact between the edge part 3017c and the flexible printed substrate 3021 is suitably prevented. Further, by configuring the gap D to be 0.8 mm or smaller, the flexible printed substrate 3021 is prevented from being bent excessively.

It is desired that a corner part 3044a of the support part 3044 have a radius of curvature of 0.5 mm or larger. In this case, the flexible printed substrate 3021 is prevented from being damaged by the corner part 3044a of the support part 3044.

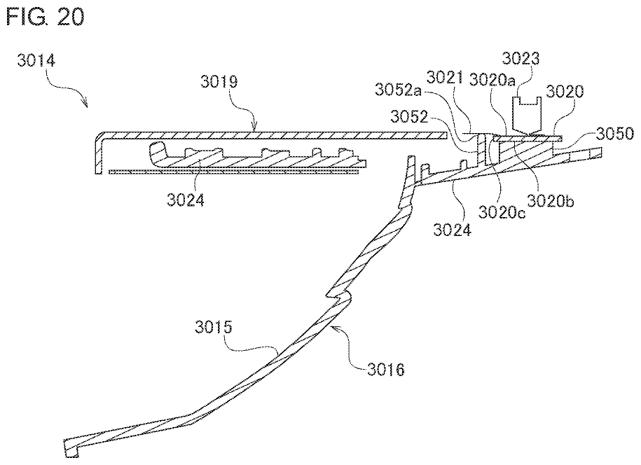

FIG. 20 is a B-B schematic cross-sectional view of the lamp unit 3014 shown in FIG. 16. A description will be given of a configuration of the vicinity of the connector circuit substrate 3020 with reference to FIG. 20.

As shown in FIG. 20, the connector circuit substrate 3020 is provided on a seat part 3050 formed on the base part 3024 of the reflector unit 3016. The surface of the connector circuit substrate 3020 opposite to a surface 3020b on the side of the base part 3024 (i.e., the upper surface of the connector circuit substrate 3020) represents a connector mounting surface 3020a. An insulating film is formed on the connector mounting surface 3020a. The connector 3023 is mounted on the insulating film, and a circuit pattern for feeding power to the connector 3023 is formed on the insulating film. Like the LED circuit substrate 3017, the connector circuit substrate 3020 is also a plate-shaped body made of a metal such as aluminum and is formed by punching out a metal plate.

The flexible printed substrate 3021 is joined to the connector mounting surface 3020a of the connector circuit substrate 3020 via a solder. As described above, the flexible printed substrate 3021 connects the connector circuit substrate 3020 and the LED circuit substrate 3017 by a wire.

In the vehicle lamp 3010 according to the fourth embodiment, the base part 3024 includes a support part 3052 that supports the flexible printed substrate 3021 such that the flexible printed substrate 3021 is spaced apart from an edge part 3020c of the connector circuit substrate 3020. The flexible printed substrate 3021, a part of which is supported by the support part 3052, is curved upward from the neighborhood of the solder, forming a gap between the edge part 3020c of the connector circuit substrate 3020 and the flexible printed substrate 3021.

In the fourth embodiment, the support part 3052 is comprised of a convex part that projects from the base part 3024. A convex part like this can be integrally formed when the base part 3024 is injection-molded and so can be easily formed. In the case of integrated resin molding, it is preferable to design the structure so that the parting line of the mold is not positioned in the support part.

It is desired that the gap between the edge part 3020c of the connector circuit substrate 3020 and the flexible printed substrate 3021 be from 0.6 mm to 0.8 mm (both inclusive). It is further desired that a corner part 3052a of the support part 3052 have a radius of curvature of 0.5 mm or larger.

Described above is an explanation of the present invention based on an exemplary embodiment. The embodiment is intended to be illustrative only and it will be understood by those skilled in the art that various modifications to combinations of constituting elements and processes are possible and that such modifications are also within the scope of the present invention.

In the embodiments described above, the light emitting device is exemplified by an LED. The light source may not be an LED so long as it is a semiconductor light emitting device. For example, semiconductor laser may be used.

What is claimed is:

1. A vehicle lamp comprising:
a circuit substrate on which a light emitting device is mounted;
a base part that supports the circuit substrate;
a reflector that extends from the base part and reflects light from the light emitting device; and
a heat absorbing plate provided to cover a surface of the base part opposite to a surface that supports the circuit substrate.

2. The vehicle lamp according to claim 1, wherein
the heat absorbing plate is a metallic plate-shaped body colored in black.

3. The vehicle lamp according to claim 1, wherein
the base part is made of a resin material, and
a front end of the heat absorbing plate is fixed to a front end of the base part by heat swaging.

4. The vehicle lamp according to claim 3, wherein
a front end of the heat absorbing plate is fixed to and sandwich a front end of the base part.

5. The vehicle lamp according to claim 1, further comprising:
a convex rib formed on a surface of the base part on a side of the reflector.

6. A vehicle lamp comprising:
a circuit substrate on which a light emitting device is mounted;
a base part that supports the circuit substrate; and
a reflector that extends from the base part and reflects light from the light emitting device, wherein
the base part and the reflector are integrally molded by injection molding, and
a slit is provided in a root part of the reflector with respect to the base part.

7. The vehicle lamp according to claim 6, wherein
a thickness of the root part of the reflector is substantially equal to a thickness the other parts of the reflector.

8. The vehicle lamp according to claim 6, wherein
a part of the root part of the reflector is formed as a slit-less part.

9. The vehicle lamp according to claim 8, wherein
the reflector is segmented into a plurality of small reflecting surfaces, and
the slit-less part is a root part of the small reflecting surface located at an end of the reflector.

10. A vehicle lamp comprising:
a circuit substrate on which a light emitting device is mounted;
a base part that supports the circuit substrate;
a reflector that extends from the base part and reflects light from the light emitting device; and
a reinforcing rib having a polygonal shape and formed on a surface of the base part on a side of the circuit substrate.

11. The vehicle lamp according to claim 10, wherein
the polygonal shape is a honeycomb shape.

12. A vehicle lamp comprising:
a circuit substrate on which a light emitting device is mounted;
a flexible printed substrate joined to a surface of the circuit substrate on which the light emitting device is mounted; and
a heat sink provided on a surface of the circuit substrate opposite to the surface on which the light emitting device is mounted, wherein
the heat sink includes a support part that supports the flexible printed substrate such that the flexible printed substrate is spaced apart from an edge part of the circuit substrate.

13. The vehicle lamp according to claim 12, wherein
the support part is comprised of a recess formed in the heat sink.

14. A vehicle lamp comprising:
a base part;
a circuit substrate provided on the base part; and
a flexible printed substrate joined to a surface of the circuit substrate opposite to a surface on a side of the base part, wherein
the base part includes a support part that supports the flexible printed substrate such that the flexible printed substrate is spaced apart from an edge part of the circuit substrate.

15. The vehicle lamp according to claim 14, wherein
the support part is comprised of a convex part that projects from the base part.

16. The vehicle lamp according to claim 12, wherein
a gap between the edge part of the circuit substrate and the flexible printed substrate is preferably from 0.6 mm to 0.8 mm.

17. The vehicle lamp according to claim 12, wherein
a corner part of the support part has a radius of curvature of 0.5 mm or larger.
